(19) United States
(12) Patent Application Publication
(10) Pub. No.: US 2021/0380042 A1
(43) Pub. Date: Dec. 9, 2021

(54) Modular and Multi-Configurable Roof Rack System

(71) Applicant: Carl A. JONSSON, Lake Oswego, OR (US)

(72) Inventor: Carl A. JONSSON, Lake Oswego, OR (US)

(73) Assignee: Tiktaalik Limited Liability Company, Lake Oswego, OR (US)

(21) Appl. No.: 17/337,272

(22) Filed: Jun. 2, 2021

Related U.S. Application Data
(60) Provisional application No. 63/035,552, filed on Jun. 5, 2020.

(51) Int. Cl. B60R 9/045

(52) U.S. Cl. CPC B60R 9/045

(57) ABSTRACT

Ladder-style vehicle rack systems having elongated side rails following left and right vehicle roof sides, with a plurality of cross rails traversing the roof at intervals to form a grid of one or more rectangular areas; with rectangular load-carrying tiles adapted to be slid into the grid structure from the vehicle sides and clamped in place, the roof rack system thus being configurable and re-configurable to suit different vehicle types and load-carrying requirements.

### CONTINUITY AND CLAIM OF PRIORITY

This is an original U.S. utility patent application that claims priority to U.S. provisional patent application No. 63/035,552 filed 5 Jun. 2020.

### FIELD

The invention relates to vehicle storage and carrying equipment. More specifically, the invention relates to a modular, reconfigurable roof rack system for securing and carrying items on the roof of a vehicle.

### SUMMARY

The Multi-configurable Roof Rack system consists of an array of inter-related components that form a defined grid system receptacle. The space defined within this grid is designated to accept re-configurable tiles. A tile as defined in this context is an insert that fits within the constraints of the grid system. Each tile can have a different function and purpose. Each tile has options for where it can be placed within this grid system. Further, the Multi-configurable Roof Rack System can be installed in multiple configurations, by re-arranging, adding or omitting a certain number of said components. Thus, the system comprises a family of compatible components that can be selected and assembled to form a vehicle rack suited to a particular vehicle and to the vehicle owner's particular needs.

### BRIEF DESCRIPTION OF DRAWINGS

The Figures show several differently-sized modules adapted for use in the inventive roof rack system, with different combinations of modules installed in various exemplary configurations of an embodiment. The system a

FIG. 1 shows an overview of an exemplary embodiment of the invention, installed on a vehicle.

FIG. 2 identifies several features and characteristics of the exemplary embodiment of FIG. 1.

FIG. 3 shows components of an embodiment in relation to a sample vehicle.

FIG. 4 shows a detail of a portion an embodiment.

FIG. 5 shows another view of a portion of an embodiment, with additional components that may be installed in some implementations.

FIG. 6 shows an exploded view of a portion of an embodiment, identifying optional features that may be present.

FIG. 7 shows a side view of a portion of an embodiment where tiles are not securely clamped to a cross member.

FIG. 8 shows a side view of a portion of an embodiment where tiles are securely clamped to a cross member.

FIG. 9 shows several alternative options for securing and releasing tiles from their adjacent cross member.

FIG. 10 shows how tiles may be arranged on a vehicle roof to avoid interference with vehicle structures.

FIG. 11 shows how the cross members of an embodiment may be arranged at non-uniform spacings.

FIG. 12 is a system diagram of an embodiment comprising solar panels and electrical storage.

FIG. 13 shows an alternative embodiment having a convex, arched profile.

FIG. 14 shows a specific organization of components to suit a particular vehicle configuration.

FIG. 15 is a top view thereof;

FIG. 16 is a bottom view thereof;

FIG. 17 is a front view thereof;

FIG. 18 is a left side view thereof;

FIG. 19 is a right side view thereof;

FIG. 20 is a rear view thereof.

FIG. 21 shows an alternate, gutter-mounted standoff that may be provided with some embodiments.

### DETAILED DESCRIPTION

A Multi-configurable Roof Rack system according to an embodiment of the invention consists of an array of inter-related components that form a defined grid system receptacle. The space defined within this grid is arranged to accept re-configurable tiles. A tile as defined in this context as an insert that fits within the constraints of the grid system. Each tile can have a different function and purpose. Each tile has options for where it can be placed within this grid system. Further, the Multi-configurable Roof Rack System can be installed in multiple configurations, by re-arranging, adding or omitting a certain number of said components.

The Multi-configurable Roof Rack System consists of a predefined number of cross members or cross bars, which are assembled to connect between right and left side or “brace” rails. The number of cross bars used depends on the configuration needed for a particular vehicle. For a long wheel base vehicle, four or more cross bars may be used. For a short wheel base vehicle, three cross bars may be sufficient. For a pick up truck cab (or similar) a system with only two cross bars may be suitable.

The cross bars traverse the roof of the vehicle and are connected to brace rails at either side. A brace rail as defined in this context as a structural extrusion or channel with the intent of providing structural support and stability to the cross bars that it is mounted to.

Each cross bar may have a “tower,” “foot” or “stand-off” at either end, near its connections to the brace rails. The tower or foot may include a flat, vertical mounting surface, that allows for stable and rigid attachment of various accessories.

The cross bars and brace rails form a grid of one or more rectangular areas. Since the brace rails and cross bars are commonly of uniform lengths, these rectangular areas are also equal-sized and -dimensioned. The system comprises “tiles”—rectangular panels that cover ¼, ⅓, ½, or all of one of the rectangular areas. Each tile may be a simple planar grid (to which other items may be secured), or a special-purpose grid comprising an integrated, optionally-locking dry container, a liquid tank (e.g., a water or fuel tank), or another specialized container. Some tiles may be covered with solar panels to generate electricity (which may be collected via contacts integrated into the tile/grid connection, and conducted to storage such as batteries located within the vehicle).

Each tile may be secured to the grid and to any adjacent tiles using a quick-release system, allowing rapid reconfiguration of the storage system. Alternatively, tiles may be more permanently secured to the grid by traditional threaded fasteners (including without limitation “security” fasteners having a non-standard driver configuration, or a “tighten-only” head.)

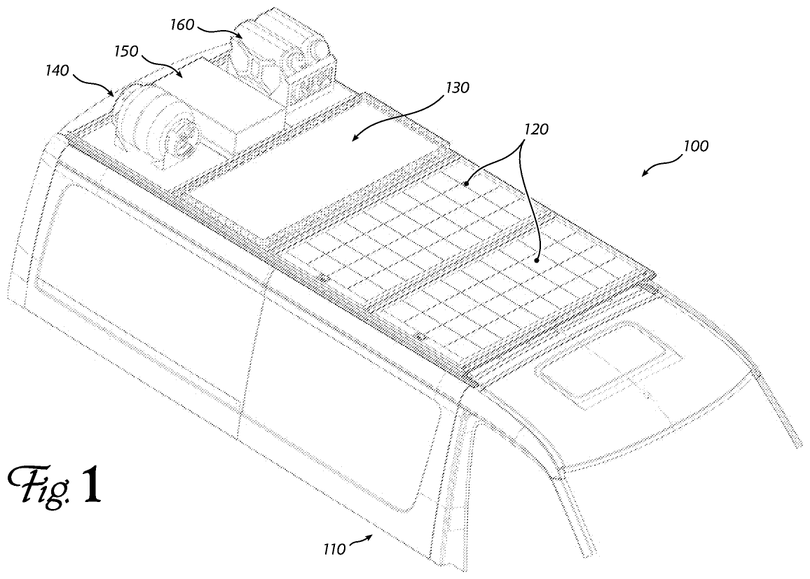

FIG. 1 shows a sample selection and arrangement of components of a modular, multi-configurable roof rack system 100 secured to the roof of a vehicle 110. In this implementation, the user has installed two solar panel modules (“tiles”) 120, a general-purpose basket rack 130, and three smaller tiles side-by-side at the rear of the vehicle: a propane cylinder 140, a covered box 150, and a rack for water or fuel containers 160. The inventive system comprises tiles for other purposes, and the space outlined by the support frame (described below) can be organized differently to distribute the load more favorably across the vehicle or to ease access to stored material and equipment. The tiles may be characterized according to the loads they are adapted to carry. For example, the solar panel modules 120 carry solar panels. The general-purpose basket rack 130 can carry objects of a range of sizes, provided that the objects can be securely strapped down to the open load-carrying basket. The propane cylinder rack 140 comprises a bracket to which a standard propane cylinder may be secured. The covered box 150 provides enclosed, preferably water-resistant storage for objects that fit within.

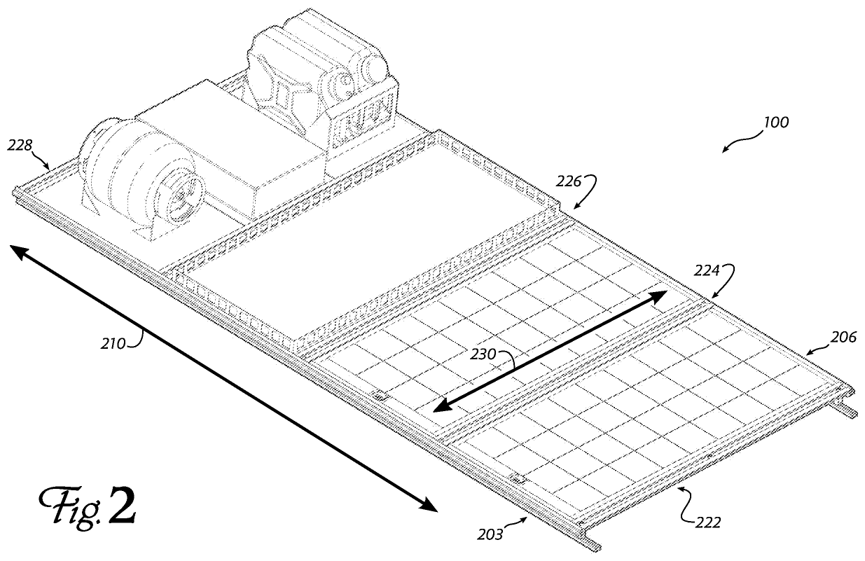

FIG. 2 identifies additional details of the rack of FIG. 1, 100. This style of rack is sometimes called a “ladder rack,” not because it is especially suitable for carrying ladders (although it can do so), but because its structure bears some similarity to a typical ladder that might be used for ascending from one level to another. Specifically, the inventive roof rack system comprises elongated members 203, 206 which extend the length of the rack (direction 210) and are located near the peripheral long edges of the structure, akin to the vertical legs of a traditional ladder. Direction 210 is usually aligned with the normal direction of travel of the vehicle.

Cross members, some of which are identified at 222, 224, 226 and 228, extend from one lengthwise member 203 to the other 206, perpendicular in direction thereto (230). These cross members are akin to the rungs of a ladder, although the entire structure is not especially suitable for use as a ladder. The lengthwise, elongated members and the perpendicular cross members generally lie in a plane and are installed near, and generally parallel to, the roof of a vehicle, so they are positioned roughly horizontally with respect to the roof and to the ground. In most embodiments, the elongated members are secured to the roof of the vehicle by four or more stand-offs (two or more stand-offs per side). The cross members are secured to the elongated members, and may be secured to stand-offs positioned along the elongated members. In some embodiments, a stand-off is positioned at every junction between a cross member end and an elongated member. It is possible that elongated rails and cross members are only secured to the stand-off where they come together (and not directly to each other), although in a preferred, stronger embodiment, the joints involve most or all of the members coming together there.

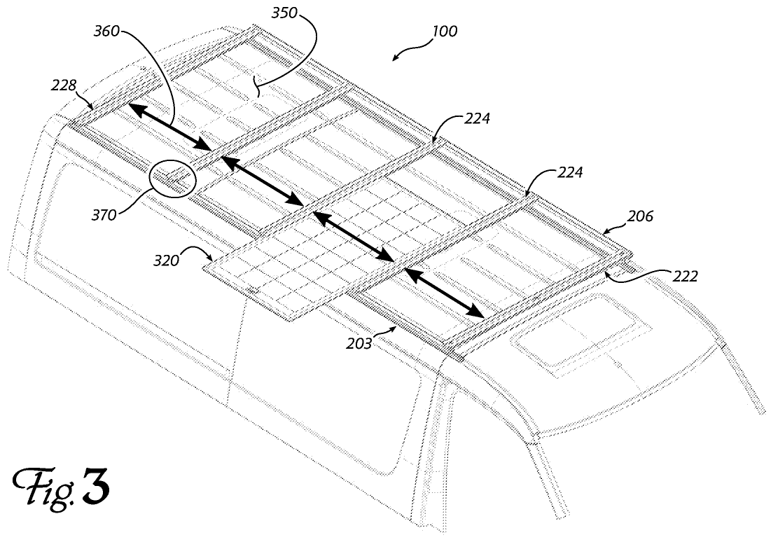

FIG. 3 shows an example roof rack structure in relation to the vehicle roof, when all but one of the load-carrying multi-functional tiles have been removed. In this condition, it is clear that the elongated members 203, 206 follow the left and right vehicle edges (in this example, they mount closely to the vehicle roof gutters—in other words, the stand-offs mentioned above are very short or even vestigial). The cross members 222, 224, 226 and 228 extend across the vehicle roof from elongated member 203 to elongated member 206. Only tile 320 is shown, and that is only partially installed, so it is apparent that the support frame structure is open and the vehicle roof 350 can be seen therethrough. The elongated rails and the cross members form the boundaries of a plurality of rectangular openings (the number of openings is one fewer than the number of cross members). In the embodiments depicted so far, the spacing between each cross member is uniform, as shown by heavy double-headed arrows 360. In some embodiments, the cross members may be secured at varying distances along the elongated members (although they should be secured perpendicularly across the roof). A cross member may even be omitted, which will expose a larger unobstructed area of the vehicle roof.

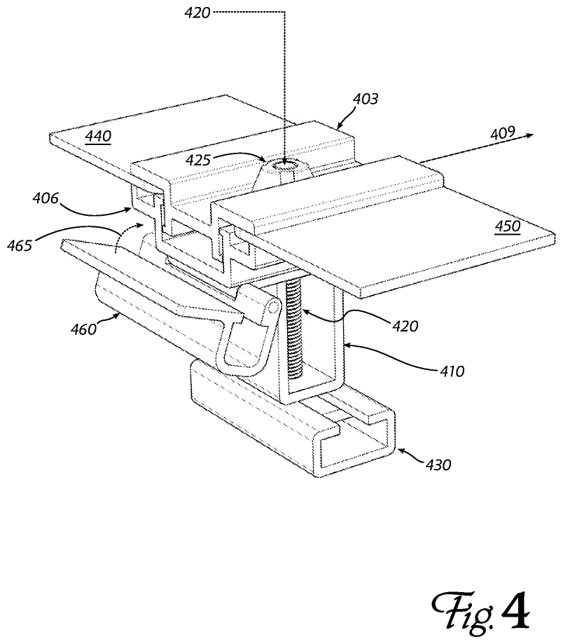

The lengthwise, elongated rails of an embodiment and the perpendicular cross members may be formed principally as extrusions of suitable profile shape, with channels and other features as described below. FIG. 4 shows a detail view of the elongated-member-to-cross-member joint circled at 370 in FIG. 3.

FIG. 4 shows a joint between the elongated member components of one side rail of an embodiment and one cross member's components. Both the elongated member and the cross member have been severed to expose interior structures. In this embodiment, the cross member comprises two lengths of extrusion: a top extrusion 403 and a bottom extrusion 406, both of which extend in direction 409 across the vehicle roof and to a mirror-image of this joint on the other side of the vehicle.

Both cross member extrusions 403, 406 are secured to a lengthwise extruded channel 460 that forms part of the elongated side rail by a threaded fastener 420. A short rectangular stand-off 410 is also connected to the cross-member extrusions and the side rail by fastener 420. The C-channel 430 at the bottom of the figure may be secured to the vehicle roof or gutter; or it may be part of the vehicle's roof or gutter itself, and adapted for securing to a roof rack system like an embodiment of the present invention. The threaded fastener 420 holds all of the foregoing elements together and to the vehicle roof, with a threaded nut 425 at the upper end. (The nut in this illustration is a security fastener: it requires a special tool to loosen or tighten. Ordinary threaded nuts may be used when special security is not needed, or a quick-release cam system as described and depicted later may be used to simplify reconfiguration of the rack's load tiles.)

The unadorned flat sheets identified at 440 and 450 are the front and rear edges of two load tiles that may be installed in the rack adjacent the cross member formed by extrusions 403 and 406. When fastener 420 is tightened, the cross-member extrusions clamp down on the load tiles to hold them in place.

Finally, in this embodiment, note that elongated side rail 460 has a hinged cover, which is open in this view, but which may be flipped up and latched as indicated by 465 to cover the ends of the cross-member extrusion and to help prevent the load tiles from sliding out even if threaded fastener 420 unexpectedly loosens.

FIG. 5 shows the same joint from a different perspective. In this illustration, hinged cover 460 has been flipped up as described earlier, so that it covers the end of the cross member structure and can help keep the load tiles in place. Note that the hinged cover in this embodiment (which may also be an extruded form) comprises a channel through which cables 510 may be routed. These cables can carry electrical current from solar-panel tiles installed in the rack to a load in the vehicle (including without limitation a battery or battery management system).

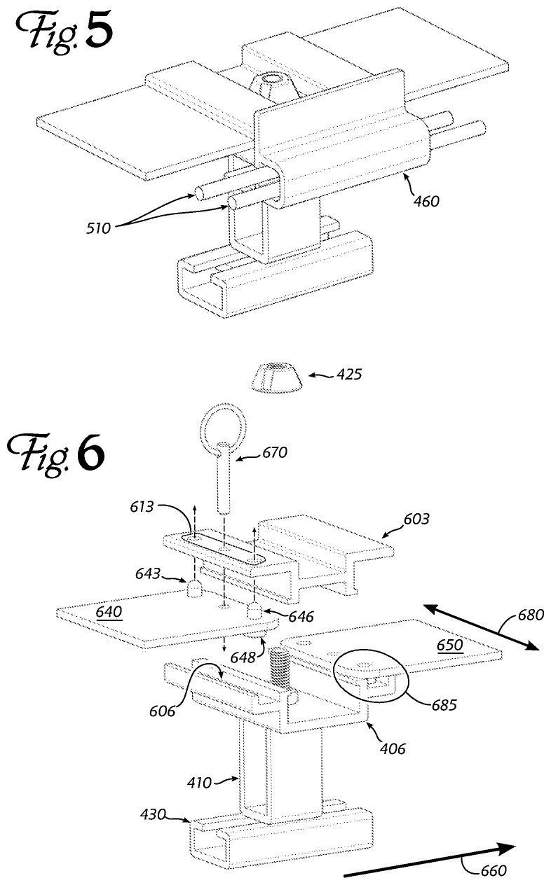

FIG. 6 shows an exploded detail of a joint similar to those described above. Security fastener 425 has been unscrewed, allowing upper cross-member extrusion 603 to be lifted up, exposing the fore and aft edges of adjacent tiles 640 and 650. (Vehicle direction is shown as 660, so the front edge of tile 640 and the rear edge of tile 650 are shown.) Lower cross-member extrusion 406, a short rectangular stand-off 410, and C-channel 430 are as described above.

In the structure of the embodiment depicted here, upper cross-member extrusion 603 comprises a plurality of holes 613, at least in the trailing flange (the portion of the extrusion that covers the front edge of tile 640). These holes may accept pins 643, 646 on the upper surface of the front edge of tile 640, or a separate keeper pin 670 may be inserted through both the upper extrusion and the front edge of the tile; in both cases to help hold the tile in place and prevent it from escaping the grasp of the clamp between the upper extrusion 603 and the lower extrusion 406.

The rear edge of a tile may have similar holes or pins, and a similar arrangement may be used to help secure the trailing edges of tiles to the leading cross-member extrusion flange. (If both, or all, edges of a tile have holes and/or pins, then the tile can be installed with either or any edge facing forward.)

On the underside of a tile, a button or rib 648 may be provided. This feature slides in a channel 606 formed in the lower cross-member extrusion 406, so that when the top cross-member extrusion is lifted and/or all pins are removed, the tiles may be slid across the roof rack (direction 680; see also 685, where the rear edge of tile 650 slides in the front channel of lower cross-member extrusion 406). A tough, low-friction plastic such as PTFE (trade name Teflon®) or polyoxymethylene (trade name Delrin®) is a suitable choice for these items. Metal may also be used, provided that the metal does not gall or otherwise interact with the cross-member material so that the tiles are difficult to slide in and out.

It is appreciated that although tile widths may be typically be standard, small fractional proportions of the overall rack width (e.g., ½, ⅓, or ¼ of the rack width), more-closely spaced holes in the upper cross-member extrusion will allow less-than-full-width tiles to be positioned more precisely across the width of the roof, to improve load centering or to avoid existing structures on the roof.

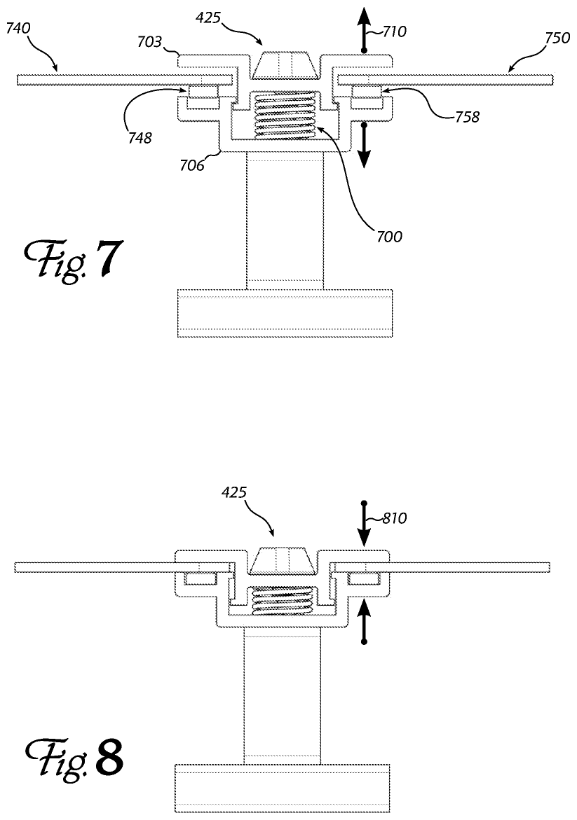

FIG. 7 shows another view of the cross-member extrusions and assembly. Here, upper cross-member extrusion 703 and lower cross-member extrusion 706 are assembled with a spring 700 between them. When security fastener 425 is loosened, the spring urges the cross-member extrusions apart 710, allowing tiles 740 and 750 to slide more easily in and out (the direction of motion is in and out of the plane of the image). As described earlier, tiles 740 and 750 may slide on PTFE or polyoxymethylene protrusions 748, 758, to reduce the effort required to insert or remove a tile (which may be carrying a substantial load). When security fastener 425 is tightened, as shown in FIG. 8, the upper and lower cross-member extrusions are urged together 810, compressing the spring and clamping down on the tile edges.

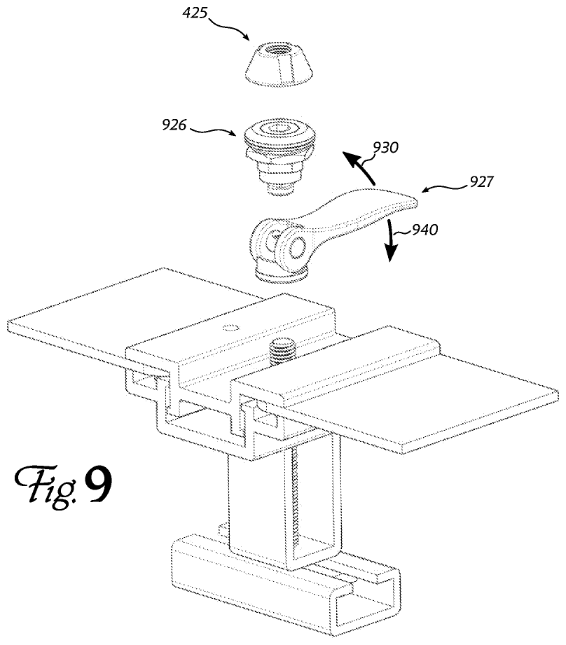

FIG. 9 shows some alternative fasteners that may be used with an embodiment. Security fastener 425 has been described earlier, but an embodiment may use an ordinary threaded fastener 926 that accepts a standard Allen wrench, or a cam-release (“quick release”) lever 927 that loosens the cross-member extrusions when the lever is lifted 930 and tightens the extrusions when the lever is pressed down 940. Fasteners may be uniform at all cross-member extrusion joints, or security fasteners may be used to clamp rarely-removed or high-value tiles, while quick-release fasteners may be used for tiles that need to be removed or repositioned frequently.

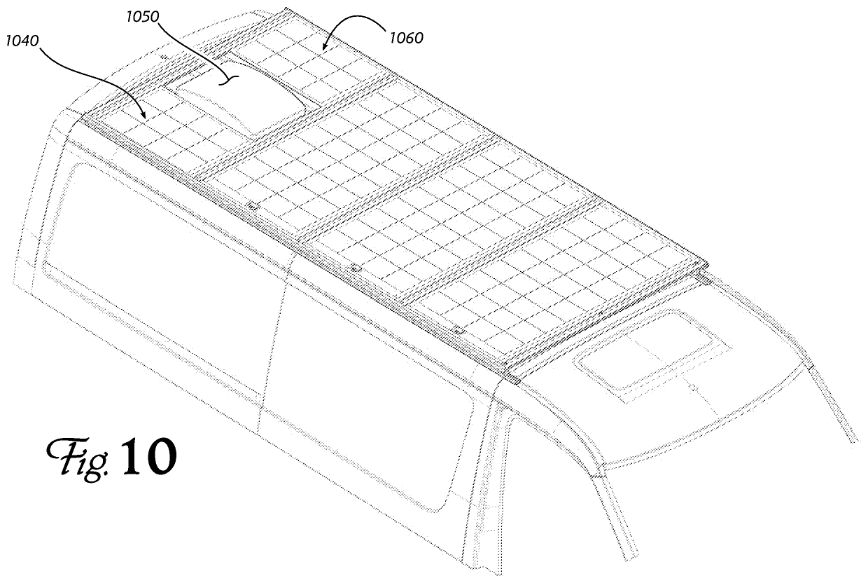

FIG. 10 shows how partial-width tiles 1040 and 1060 may be arranged within an embodiment to leave an open space so that a structure on the roof of the vehicle (here, an exhaust fan shroud 1050) is unobstructed. Openings can be left even when the vehicle-roof structure would not interfere with the roof-rack tile. For example, a window on the roof surface (a “moon roof” or a “sun roof”) may be left uncovered to admit light.

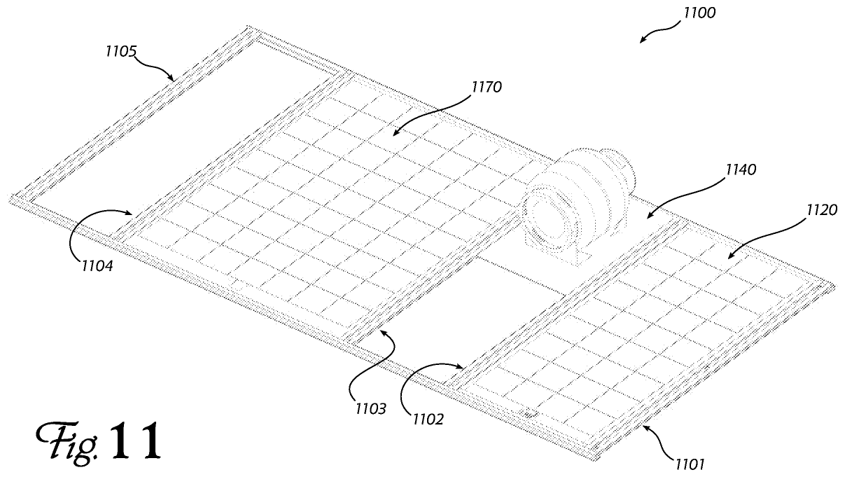

FIG. 11 shows an embodiment of the invention 1100 where the cross-members have been arranged with uneven spacing along the elongated side rails. Solar-panel tile 1120 has the same proportions as in previous illustrations, but the ⅓ width tile 1140 carrying a propane tank has been installed with a 90° rotation from the orientation shown, e.g., in FIG. 1, so the distance between the second and third cross members (1102, 1103) is narrower than the distance between the first and second cross members (1101, 1102). Similarly, solar-panel tile 1170 is a different aspect ratio from tile 1120, so the distance between the third and fourth cross members (1103, 1104) is greater than the other cross-member distances.

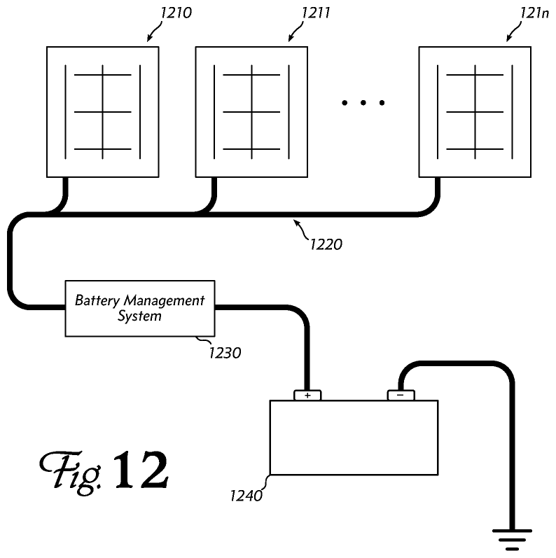

FIG. 12 shows a system block diagram of one embodiment of the invention. This embodiment comprises a multi-configurable roof rack system like those described above, including a plurality of solar-panel tiles 1210, 1211, . . . 121n. These are coupled via cables 1220, which may be routed as described in reference to FIG. 5, to a battery management system 1230 that conditions the power from the solar panels so that it can charge battery 1240 without overcharging. Battery 1240 stores power for later use by various vehicle systems, which may be operated even when the solar panel output is low or zero.

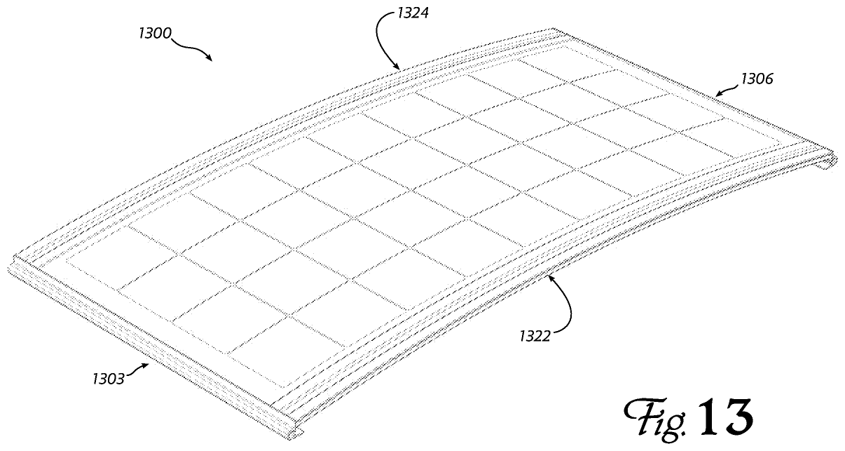

FIG. 13 shows a portion of another embodiment of the invention 1300. This embodiment has the same general “ladder rack” structure of previous embodiments, but the cross members 1322, 1324 have a convex, arched curvature as they extend from the right elongated side rail 1303 to the left elongated side rail 1306. This shape may provide aerodynamic or structural-strength benefits, and/or may conform more closely to a vehicle roof, improving the structure's aesthetics. The tiles 1330 are similar to previously-described tiles (including having optional alignment pins, sliding buttons or rails, etc.) but are flexible enough to be captured securely by the arched cross members (or are pre-formed with a suitable arch shape).

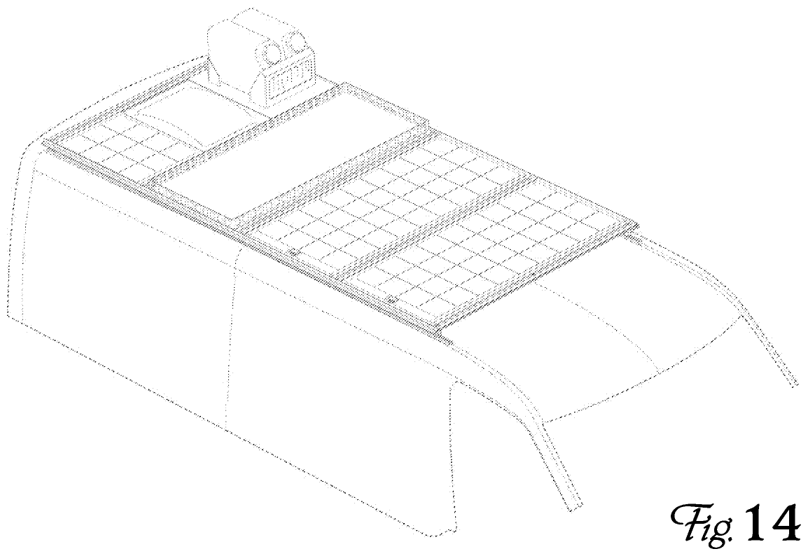

FIG. 14 shows a perspective view of an exemplary embodiment of the invention, with a selection of tiles and arrangement adapted to a common vehicle configuration.

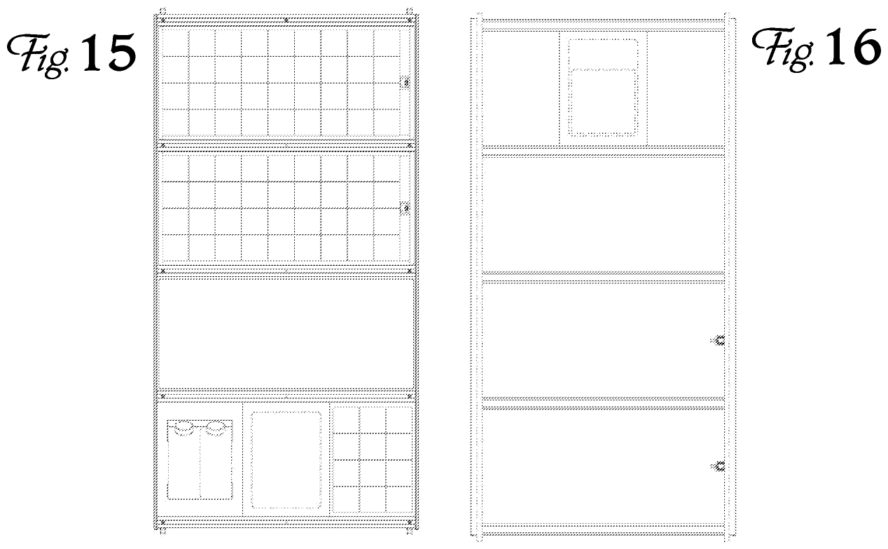

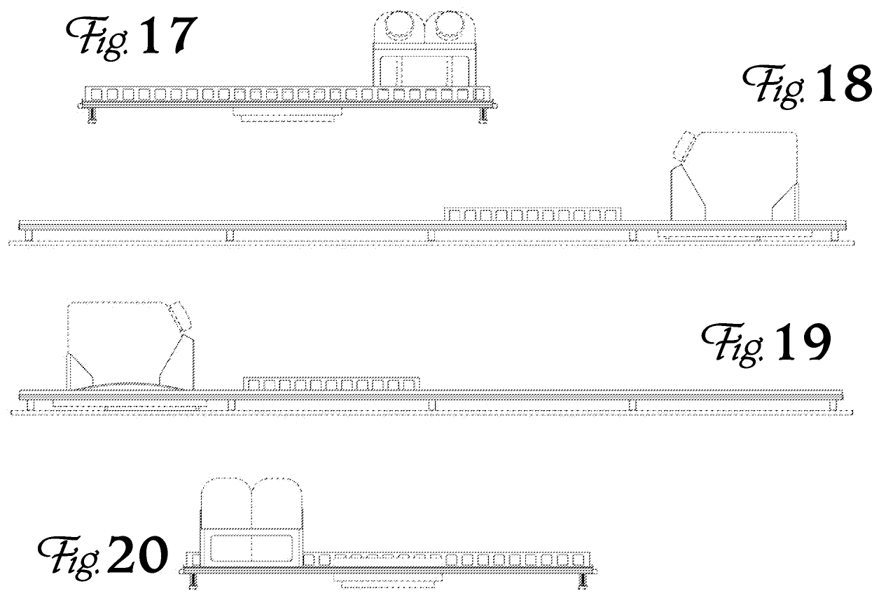

FIGS. 15-20 show top, bottom, front, left, right, and rear views of this exemplary embodiment, respectively. Dashed lines are directed environment and form no part of the claimed invention.

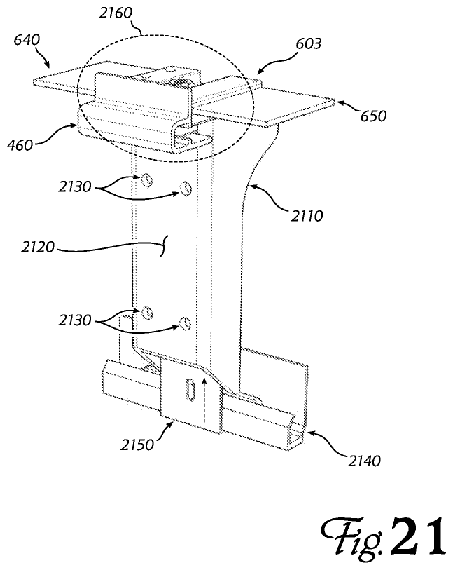

FIG. 21 shows a different stand-off structure that may be used with an embodiment of the invention. Stand-off 2110 is longer than previously-depicted structures, so the rack system is held higher over the vehicle roof. The stand-off may include a flat vertical face 2120 with an array of accessory holes 2130 for attaching equipment or tie-down eyelets. The stand-off is secured to a vehicle gutter 2140 by way of a clamp-like member 2150, which may be tightened down on the gutter as shown by the dashed arrow.

At the upper end of the stand-off 2110, other elements of the inventive ladder rack join together in the area generally circled at 2160: cross-member upper extrusion 603, side rail 460, and adjacent load tiles 640 and 650. This joint is secured by a threaded fastener, which is mostly obscured by other structure in the figure and is therefore not marked with a reference character.

The applications of the present invention have been described largely by reference to specific examples and in terms of particular allocations of functionality to certain physical components or structures. However, those of skill in the art will recognize that reconfigurable, modular roof racks can also be constructed in alternate forms that distribute the functions of embodiments of this invention differently than herein described. Such variations and implementations are understood to be captured according to the following claims.

I claim:

1. A modular reconfigurable roof rack system for a vehicle, comprising:
a plurality of transverse rails of uniform transverse length adapted to be secured to a roof of a vehicle, each such transverse rail spaced apart from its neighbors by a uniform spacing distance along a length of the vehicle;
a plurality of longitudinal rails of uniform longitudinal length, two such longitudinal rails joining each pair of adjacent transverse rails;
a first rectangular rack tile having a first dimension approximately equal to the uniform spacing distance and a second dimension approximately equal to the uniform transverse length;
a second rectangular rack tile having a first dimension approximately equal to the uniform spacing distance and a second dimension approximately equal to half of the uniform transverse length; and
a third rectangular rack tile having a first dimension approximately equal to the uniform spacing distance and a second dimension approximately equal to one third of the uniform transverse length, wherein
at least one of the first rectangular rack tile, the second rectangular rack tile and the third rectangular rack tile is secured to a predetermined position in the roof rack system by two of the plurality of transverse rails.

2. The modular reconfigurable roof rack system of claim 1 wherein each joint between an end of a transverse rail of the plurality of transverse rails and a longitudinal rail of the plurality of longitudinal rails is held together by a threaded fastener, said threaded fastener being secured by one of a security threaded nut, a standard threaded nut, or a quick-release cam lever.

3. The modular reconfigurable roof rack system of claim 1 wherein the first rectangular rack tile comprises solar cells.

4. The modular reconfigurable roof rack system of claim 1 wherein the second rectangular rack tile comprises an open load-carrying basket.

5. The modular reconfigurable roof rack system of claim 1 wherein the third rectangular rack tile comprises a covered load-carrying box.

6. The modular reconfigurable roof rack system of claim 1 wherein the third rectangular rack tile is adapted to secure a cylindrical propane tank.

7. The modular reconfigurable roof rack system of claim 1 wherein one longitudinal rail of the plurality of longitudinal rails comprises a closeable channel carrying at least one electrical conductor.

8. A reconfigurable ladder-style roof rack system for a vehicle, comprising:
two elongated members secured to a roof of a vehicle in a direction roughly parallel to a direction of travel of the vehicle, a first of the two elongated members secured near a left side of the roof and a second of the two elongated members secured near a right side of the roof;
at least three cross members extending perpendicularly from the first elongated member to the second elongated member, said at least three cross members spaced apart from each other;
a first rectangular tile sized to fit between two adjacent cross members and to extend fully from the first elongated member to the second elongated member;
a second rectangular tile and a third rectangular tile, said second and third rectangular tiles sized to fit between two adjacent cross members and to extend partway from the first elongated member to the second elongated member, wherein
the second rectangular tile and the third rectangular tile together occupy substantially all of a distance between the first elongated member and the second elongated member.

9. The reconfigurable ladder-style roof rack system of claim 8 wherein the first rectangular tile, the second rectangular tile and the third rectangular tiles are adapted to accept different load objects.

10. The reconfigurable ladder-style roof rack system of claim 9 wherein the different load objects are selected from the group consisting of solar panels, propane cylinders, fuel containers and water containers.

11. The reconfigurable ladder-style roof rack system of claim 8 wherein one of the rectangular tiles comprises an open load-carrying basket.

12. The reconfigurable ladder-style roof rack system of claim 8 wherein one of the rectangular tiles comprises a closed, water-resistant load-carrying box.

13. A modular reconfigurable rack system for a vehicle, comprising:
a left elongated rail secured to a left side of a vehicle roof;
a right elongated rail secured to a right side of the vehicle roof;
at least three cross rails extending across the vehicle roof from the left elongated rail to the right elongated rail, each cross rail spaced apart from an adjacent cross rail to form a plurality of rectangular openings bounded by the left elongated rail, the right elongated rail and an adjacent pair of cross rails;
a plurality of load tiles sized to occupy at least part of one rectangular opening of the plurality of rectangular openings, at least one of said load tiles being adapted to carry a different type of load from at least another of said load tiles.

14. The modular reconfigurable rack system of claim 13 wherein each cross rail of the at least three cross rails comprises an upper extrusion and a lower extrusion, said upper and lower extrusions operative to clamp together on edges of a load tile of the plurality of load tiles that is installed adjacent the respective cross rail of the at least three cross rails.

15. The modular reconfigurable rack system of claim 14 wherein the upper extrusion and the lower extrusion of a cross rail are separated by a spring to urge the upper extrusion and the lower extrusion apart.

16. The modular reconfigurable rack system of claim 14 wherein the upper extrusion of a cross rail comprises a plurality of holes in a trailing flange thereof, and wherein a load tile of the plurality of load tiles comprises a plurality of pins along a pinned edge thereof, such that the plurality of pins mate with the plurality of holes when the upper extrusion is clamped together with the lower extrusion and onto the pinned edge of the load tile.

17. The modular reconfigurable rack system of claim 14 wherein the upper extrusion of a cross rail comprises a plurality of holes in a trailing flange thereof, and wherein
a load tile of the plurality of load tiles comprises a plurality of holes along a drilled edge thereof, the modular reconfigurable rack system further comprising
at least one keeper pin sized to pass through one of the plurality of holes in the trailing flange of the upper extrusion and through one of the plurality of holes along the drilled edge of the load tile, so that
the load tile is positively secured to the trailing flange of the upper extrusion by the keeper pin.

18. The modular reconfigurable rack system of claim 14 wherein the lower extrusion comprises a channel, and wherein a load tile of the plurality of load tiles comprises a reduced-friction slider on a lower surface thereof, so that the reduced-friction slider of the load tile slides in the channel of the lower extrusion when the load tile is installed into the modular reconfigurable rack system.

19. The modular reconfigurable rack system of claim 18 wherein the low-friction slider is formed from PTFE or polyoxymethylene.

20. The modular reconfigurable rack system of claim 13 wherein the at least three cross rails are curved to form a convex arc over the vehicle roof.
